(19) United States
(12) Patent Application Publication
(10) Pub. No.: US 2026/0361793 A1
(43) Pub. Date: Nov. 12, 2026

(54) SYSTEMS AND METHODS FOR GENERATING SECURED OUTPUTS OVER COMPUTER NETWORKS USING A TWO-STAGE ARCHITECTURE

(71) Applicant: Capital One Services, LLC, McLean, VA (US)

(72) Inventors: Genta WINATA, New York, NY (US); Ayushman SINGH, McLean, VA (US); Aashay Pinkesh MEHTA, McLean, VA (US); Chia-Hsuan LEE, McLean, VA (US); Jisoo KIM, McLean, VA (US)

(73) Assignee: Capital One Services, LLC, McLean, VA (US)

(21) Appl. No.: 19/205,871

(22) Filed: May 12, 2025

(51) Int. Cl. H04L 67/142; G06F 16/25

(52) U.S. Cl. CPC H04L 67/142; G06F 16/252

(57) ABSTRACT

Systems and methods for generating outputs over computer networks using a two-stage architecture. The system may use a structured constrained decoding process with to two stages: (1) a session state tracking structures (e.g., which may monitor the state of dialogue in a user interaction, track user goals, and convert determined dialogue states into inputs for the second stage) and (2) a database tool calling structure (e.g., a module that retrieves user-required information from databases or executes user-desired actions via API calls).

### BACKGROUND

Leveraging language models to effectively capture user intents and slots for complex multi-turn task-oriented dialogue is technically challenging due to several interrelated factors. First, maintaining context over multiple conversational turns is difficult; language models must accurately track evolving user goals and referents, which may change or reappear in later turns. This requires robust memory mechanisms and contextual understanding that go beyond single-turn processing. Second, disambiguating intents and extracting slot values in noisy, informal, or incomplete utterances demands high precision, especially when users correct themselves, refer back to earlier topics, or shift domains mid-dialogue. Third, task-oriented systems often require grounding in external knowledge bases or application programming interfaces (“APIs”), so the model must align natural language understanding with structured schema representations in real time. Furthermore, the lack of large, high-quality annotated datasets for multi-turn dialogues limits supervised learning approaches. Finally, ensuring consistency, robustness, and real-world deployability (e.g., handling out-of-distribution inputs and maintaining user trust) remains an open challenge when adapting large language models to such constrained and goal-driven settings.

### SUMMARY

Systems and methods are described herein for novel uses and/or improvements to generating outputs. As one example, systems and methods are described for generating outputs over computer networks using a two-stage architecture. For example, the system may use a structured constrained decoding process with to two stages: (1) a session state tracking structures (e.g., which may monitor the state of dialogue in a user interaction, track user goals, and convert determined dialogue states into inputs for the second stage) and (2) a database tool calling structure (e.g., a module that retrieves user-required information from databases or executes user-desired actions via API calls).

For example, conventional systems may approach session state tracking as a slot—classification problem; however, this approach has limited flexibility and scalability. An alternative approach is to use large language model; however, the training examples and unconstrained outputs limit consistency and accuracy. To overcome these technical problems, the system integrates a finite-state automaton into the decoding process, ensuring that every generated state strictly adheres to a predefined structure. By doing so, the system may determine the consistency and accuracy of slot-classification, but with the flexibility and scalability of a large language model.

In some aspects, systems and methods for generating outputs over computer networks using a two-stage architecture. For example, the system may receive a first user input. The system may determine a first session state tracking structure based on the first user input. The system may determine a first network input based on the first session state tracking structure and the first user input. The system may input the first network input into a first model to generate a first network output, wherein the first model is trained to generate session state tracking statuses based on dynamically determined session state tracking structures. The system may determine a first database tool structure. The system may determine a second network input based on the first user input and the first database tool structure. The system may input the second network input into a second model to generate a second output, wherein the second model is trained to generate database tool requests based on current session states and dynamically determined database tool structures. The system may execute a first database tool request based on the second output.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for user interface, in accordance with one or more embodiments.

FIG. 2A shows an illustrative diagram for a two-stage architecture for generating outputs, in accordance with one or more embodiments.

FIG. 2B shows an illustrative diagram for a session state tracking structure, in accordance with one or more embodiments.

FIG. 2C shows an illustrative diagram for a database tool structure, in accordance with one or more embodiments.

FIG. 3 shows illustrative components for a system used to generate outputs over computer networks using a two-stage architecture, in accordance with one or more embodiments.

FIG. 4 shows a flowchart of the steps involved in generating outputs over computer networks using a two-stage architecture, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

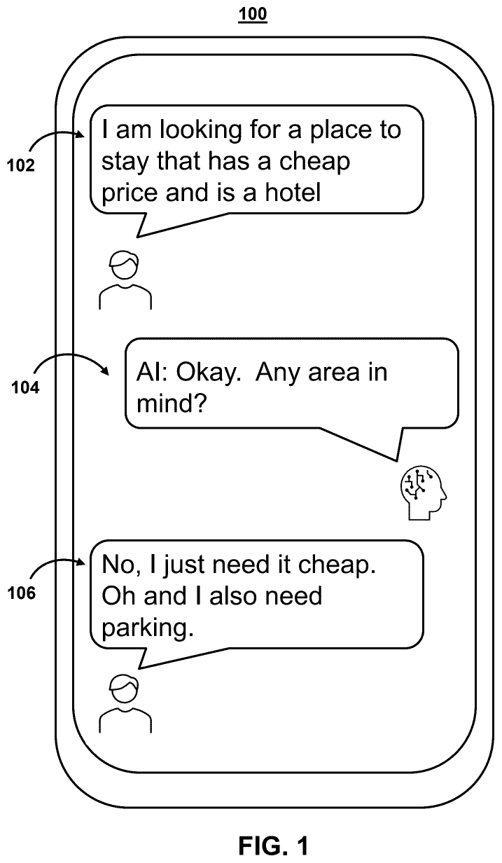

FIG. 1 shows an illustrative diagram for user interface, in accordance with one or more embodiments. For example, FIG. 1 shows user interface 100, which is currently hosting a user session between a first user and automated application (e.g., a chatbot). During the interaction, the user issues user input 102 and user input 106 and received response 104.

For example, user interface 100 is actively hosting a session between a first user and an automated application, such as a chatbot or task-oriented dialogue assistant. The interface presents a back-and-forth exchange where the user initiates the conversation with a request, shown as user input 102, stating: “I am looking for a place to stay that has a cheap price and is a hotel.” In response, the AI system analyzes the input and issues response 104, which reads: “AI: Okay. Any area in mind?”—a clarification prompt intended to refine the search parameters based on geographic preference. The user then replies with user input 106, stating: “No, I just need it cheap. Oh and I also need parking.” This continuation expands on the user's criteria by reinforcing the need for affordability and introducing an additional requirement (parking). This figure exemplifies a typical multi-turn dialogue in which the system incrementally tracks the user's intent and extracts structured data, such as accommodation type, pricing preference, and required amenities, likely as part of the system's dialogue state tracking and tool-calling process.

As described herein, a user interface (UI) may comprise the point of interaction between a human user and a computer system, application, or device. It encompasses all the elements that enable a user to communicate with and control a system, ranging from visual layouts and command inputs to auditory signals and haptic feedback. The primary goal of a UI is to make the interaction intuitive, efficient, and effective, allowing users to perform tasks or access information with ease.

Within this broad category, there are several sub-definitions based on the modality and context of interaction. A graphical user interface (GUI), for example, refers to visual interfaces that use icons, buttons, menus, and other graphical elements, commonly found in desktop applications and mobile apps. A command-line interface (CLI) is a text-based UI where users type commands into a console or terminal, offering greater control and flexibility for technical users. A voice user interface (VUI) enables interaction through spoken language, such as those used in smart assistants like Alexa or Siri. Another category is the natural user interface (NUI), which incorporates gestures, touch, or motion tracking, often found in gaming systems or AR/VR environments. Each of these subtypes represents a tailored approach to facilitating user interaction based on the capabilities of the system and the needs of its users.

As described herein, a user session may refer to a continuous interaction between a user and a system—such as a web application, mobile app, or conversational agent—that begins when the user initiates contact and lasts until the interaction is terminated or times out. A session serves as a container for maintaining context and state across multiple exchanges, enabling the system to deliver a coherent and personalized experience. A session is typically initiated when a user logs into an application, opens a website, sends a message to a chatbot, or performs any action that triggers the system to begin tracking their activity. At that point, the system may create a unique session identifier and begin storing data relevant to that session.

Session tracking may be used for managing context over time, particularly in multi-turn dialogues or tasks that require step-by-step inputs. The system may track a range of information, including dialogue history, user preferences, slot-value pairs, or intermediate task states. For example, in a task-oriented dialogue system, the system may generate and update a structured dialogue history that records user inputs, system responses, and derived dialogue states throughout the session. This enables the system to remember what has already been discussed, infer the user's intent more accurately, and make appropriate decisions in future responses. Sessions can be managed in-memory during live interactions, or persisted in databases for long-term user personalization, auditing, or re-engagement purposes.

As described herein, a dialogue history is a sequential record of the interactions that occur between a user and a system during a conversation. It typically includes all previous user inputs and system responses, structured in chronological order, and serves as the conversational context that informs the system's understanding and behavior in ongoing exchanges. Dialogue history may be used in multi-turn dialogue systems—such as virtual assistants or customer service bots—because it allows the system to maintain continuity, track user intents and preferences, resolve references (e.g., pronouns or omitted details), and respond appropriately based on prior conversation. This history may be stored in various formats, ranging from raw text logs to structured representations that include annotations, such as identified intents, extracted slot values, and system actions. Maintaining a complete and accessible dialogue history enables the system to perform accurate dialogue state tracking, manage complex tasks, and deliver personalized, context-aware responses throughout the session.

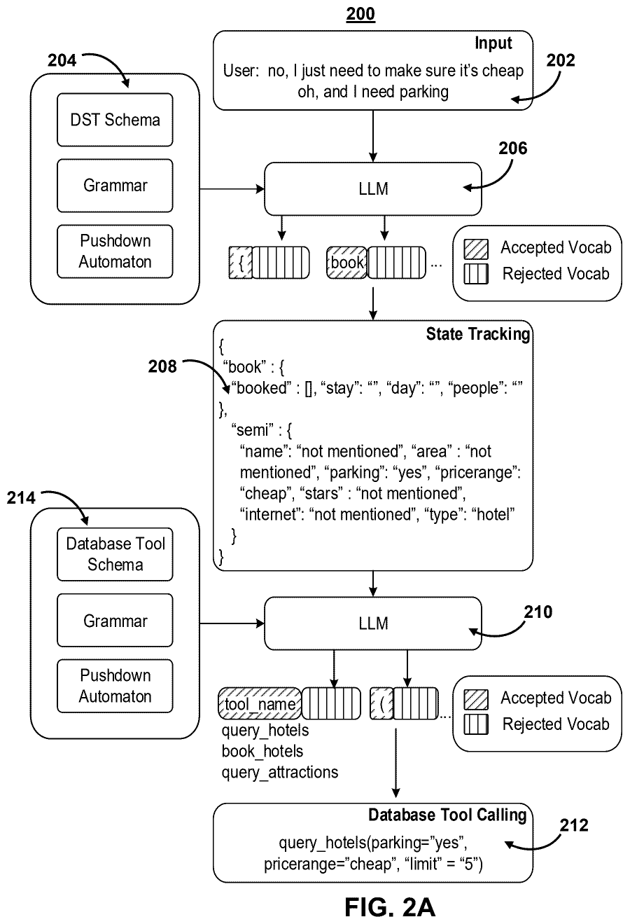

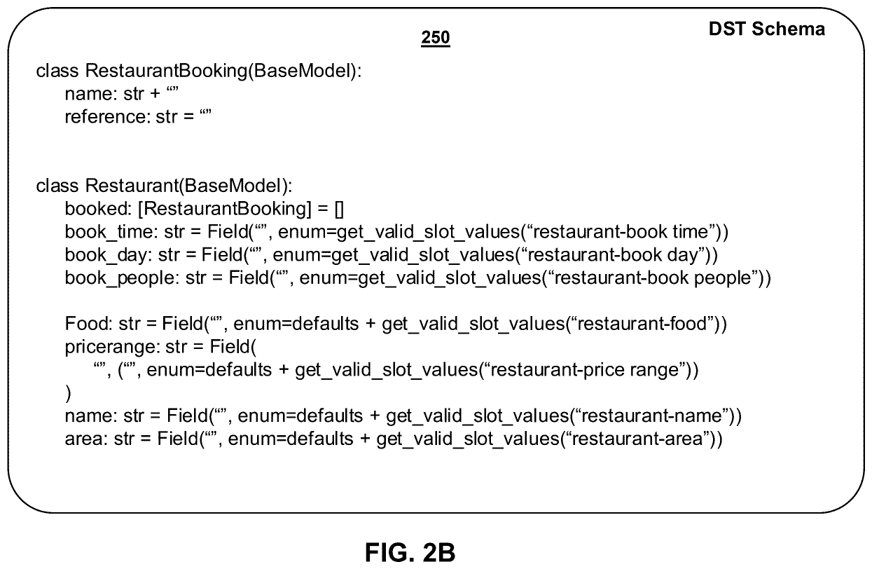

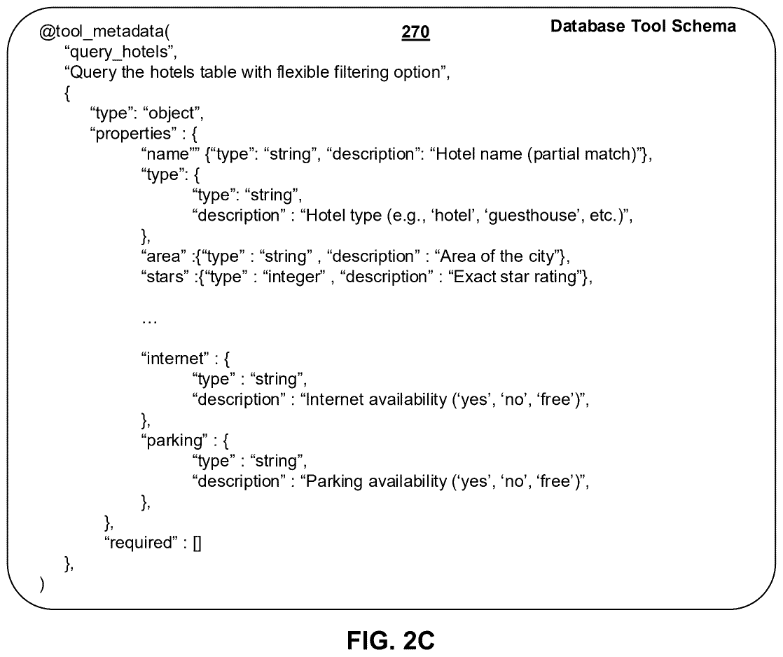

FIG. 2A shows an illustrative diagram for a two-stage architecture for generating outputs, in accordance with one or more embodiments. For example, as shown in FIG. 2A-C, system 200 may receive a first user input. The system may determine a first dialogue state tracking structure (e.g., structure 208) based on the first user input (e.g., input 202). The system may determine a first network input based on the first dialogue state tracking structure (e.g., structure 204) and the first user input (e.g., input 202). The system may input the first network input into a first model (e.g., model 206) to generate a first network output, wherein the first model (e.g., model 206) is trained to generate dialogue state tracking statuses based on dynamically determined dialogue state tracking structures (e.g., structures 214). The system may determine a first database tool structure (e.g., structure 212). The system may generate a second network input based on the first user input and the first database tool structure. The system may input the second network input into a second model (e.g., model 210) to generate a second output, wherein the second model is trained to generate database tool calls based on current dialogue states and dynamically determined database tool structures. The system may execute a first database tool call based on the second output.

For example, the system first receives a user input (e.g., input 202), such as a spoken or typed request in a dialogue interface. It then determines a session state tracking structure (e.g., structure 208) based on this input, where this structure includes a predefined set of slots (e.g., “location”, “date”, “service_type”) and their expected formats or values. The system constructs a first network input that incorporates both the raw user input and the session state tracking structure, effectively aligning free-form language with a structured schema. This input is passed into a first model (e.g., model 206), a large language model (LLM), which is trained to generate session states—that is, mappings of slots to values—by emitting outputs that strictly conform to a schema enforced by a finite-state automaton. During decoding, the automaton dynamically restricts the LLM's token choices so that only schema-valid outputs are allowed at each step, ensuring well-formed session state predictions.

Once the dialogue state is determined, the system identifies a database tool calling structure (e.g., structure 212) that defines how to interact with external services, such as databases or APIs, based on the recognized user goals. The system then constructs a second network input using both the original user input and the generated session state information formatted according to the database tool structure. This input is processed by a second model (e.g., model 210), which is trained to produce tool-or API-specific requests. Like the first model, this stage also utilizes constrained decoding governed by a finite-state automaton to ensure that all generated tool calls are valid and executable. Finally, the system executes the generated tool request—such as querying a database or triggering an external API—thereby fulfilling the user's intent in a reliable and schema-compliant manner.

In some embodiments, the system may ensure accurate and reliable dialogue state tracking by defining and enforcing a structured process for slot representation and state emission. At the core of this process is the schema definition, which involves predefining all relevant slots—such as location, date, or service_type—along with their permissible value formats. This schema acts as a blueprint capturing the universe of possible user intents and goals, thereby reducing ambiguity and guiding structured interpretation of natural language inputs.

To enforce adherence to this schema during inference, the system employs an automaton construction phase. Here, the slot-value grammar is encoded in a deterministic finite-state automaton (FSA), which encodes rules for valid slot-value pair emissions. For instance, a valid emission might follow the pattern slot_name→“=”→slot_value→“;”. This automaton not only models the allowable sequences of tokens but also implicitly validates their structure as the LLM generates output.

During inference, the system uses constrained decoding, wherein the automaton is integrated directly into the LLM's decoding loop. At each generation step, the FSA masks the LLM's logits, effectively filtering out any token that would violate the schema. This dynamic control ensures that only structurally valid continuations are permitted, guiding the LLM toward producing well-formed outputs. The result of this decoding process is a structured state output, typically in a JSON format, that captures the current dialogue state as a set of slot-value pairs. The state is only emitted once the automaton reaches an accepting state, guaranteeing that the final output fully conforms to the predefined schema and is suitable for downstream modules like API invocation or database querying.

In some embodiments, the system may determine acceptable and rejected vocabulary, which may play a central role in enforcing structured constrained decoding during the generation of both dialogue states and tool-calling outputs. As the language model progresses through token generation, the system dynamically determines which tokens are acceptable—that is, valid according to the current position within the predefined schema encoded by the finite-state automaton (FSA). At each decoding step, the automaton references the current state and identifies the set of tokens that can legally follow based on slot definitions and formatting rules (e.g., expecting an “=” symbol after a slot name, or a specific slot value format afterward). These acceptable tokens are preserved and allowed to be sampled by the language model.

Conversely, any tokens that violate the schema—those that would lead to malformed slot-value pairs or break the syntactic structure of the expected output—are labeled as rejected vocabulary. These tokens are masked out from the model's logits before sampling, ensuring they are never emitted during generation. This vocabulary control mechanism effectively constrains the model's output space in real time, reducing the likelihood of invalid, incomplete, or inconsistent dialogue states and API call formats. By tightly coupling the FSA with the decoding process, the system ensures that only syntactically and semantically valid outputs are produced, which is critical for maintaining downstream reliability and task fulfillment in robust, multi-turn task-oriented dialogue systems.

FIG. 2B shows an illustrative diagram for a session state tracking structure, in accordance with one or more embodiments. For example, FIG. 2B shows session state tracking structure 250. Session state tracking structure 250 illustrates a Dialogue State Tracking (DST) Schema, which represents the session state tracking structure used by a task-oriented dialogue system to model and monitor user goals across a conversation. The figure shows a Python-style class-based data model that defines structured fields corresponding to user intents and slot-value pairs relevant to a restaurant booking scenario. The schema includes two classes: RestaurantBooking, which appears to manage metadata like a booking reference, and Restaurant, which encapsulates the core user preferences and constraints for a restaurant query.

Within the Restaurant class, several fields are defined using Field( ) constructors that are linked to enumerated sets of valid values retrieved from functions like get_valid_slot_values( ). These fields include: book_time, book_day, and book_people (related to the logistics of the reservation), as well as food, price_range, name, and area (describing the type and attributes of the restaurant). Each slot is associated with a list of acceptable inputs, allowing the system to validate user utterances against this schema during inference. For example, the price_range field would only accept predefined categories such as “cheap”, “moderate”, or “expensive”, while the area slot might be limited to geographic regions like “center”, “north”, or “riverside”.

This schema plays a critical role in dialogue state tracking by defining the allowable structure of the dialogue state and enabling structured constrained decoding. During a session, as the system interprets user inputs, it populates these slots with extracted values, ensuring that all updates conform to the valid formats and options specified in the schema. This structured representation allows for accurate, consistent state tracking and facilitates downstream tasks such as tool invocation or database querying.

FIG. 2C shows an illustrative diagram for a database tool structure, in accordance with one or more embodiments. For example, FIG. 2C shows database tool structure 270. For example, FIG. 2C depicts a Database Tool Schema, which outlines the structure of tool-calling parameters used by a system to query an external database—in this case, a hotel listings table—with a set of flexible filtering options. The figure illustrates a @tool_metadata annotation for a method named “query_hotels”, specifying that the function accepts a “query” object containing various fields for filtering hotel search results based on user preferences. Each field within the “query” object is described with a type and a description, enabling the dialogue system to generate well-formed, semantically valid tool calls.

The schema includes fields such as “name” (a string that supports partial hotel name matching), “type” (a string indicating the accommodation category, e.g., “hotel” or “guesthouse”), “area” (a string for city regions), and “stars” (an integer representing the hotel's star rating). Additionally, two binary preference fields—“internet” and “parking”—are also present, each defined as string types with controlled values like “yes”, “no”, or “free” to indicate availability of internet and parking services, respectively. These definitions provide structured constraints that the system uses during tool invocation, ensuring that only permissible parameters are passed to the database query.

This schema is used for constrained tool-calling, as it maps user-stated preferences into a structured request format that complies with the external service's input requirements. By using this schema during the decoding process, the system can enforce that each generated API call or query adheres to expected formats, reduces the risk of errors, and maximizes the likelihood of successfully retrieving relevant information from the underlying hotel database.

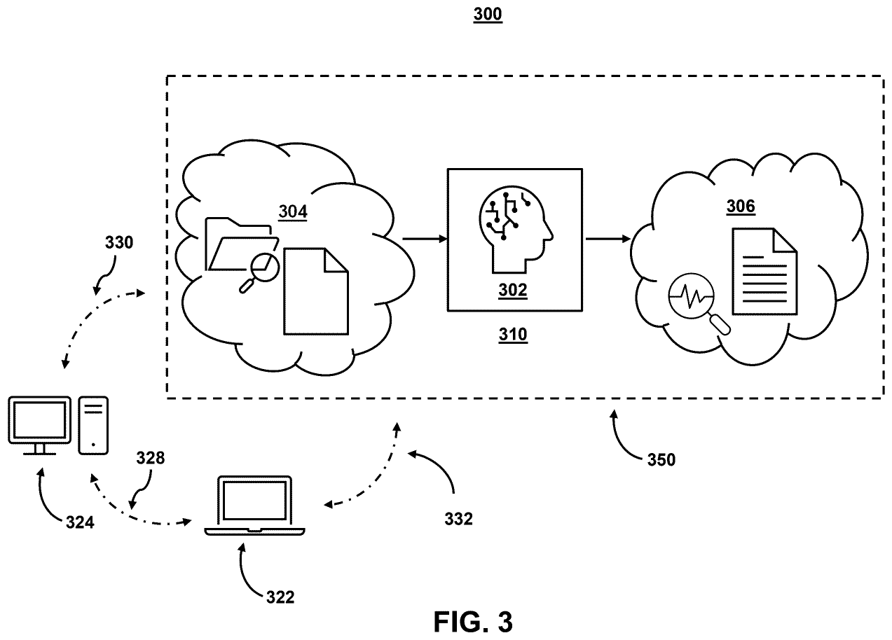

FIG. 3 shows illustrative components for a system used to generate outputs over computer networks using a two-stage architecture, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., interpreting a user input, determining a session state tracking structure, determining a network input, determining a database tool structure, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, a model may be trained to generate session state tracking statuses based on dynamically determined session state tracking structures by using supervised learning techniques on annotated dialogue datasets that reflect a variety of task domains and dialogue schemas. During training, the model is exposed to input examples comprising user utterances—often along with the dialogue history—and corresponding ground truth dialogue states formatted according to predefined schemas. These schemas vary across domains (e.g., hotel booking, restaurant search, flight reservations) and define the allowable slots and value types the model must learn to detect and populate.

The training data consists of paired examples where each user input (or sequence of inputs) is associated with a correct set of slot-value annotations, typically expressed in structured formats such as JSON. For instance, a sample might include the user utterance “I'm looking for a cheap hotel with parking” paired with a dialogue state like {“price_range”: “cheap”, “type”: “hotel”, “amenities”: [“parking”]}. To ensure adaptability across different schemas, the model may also be trained with schema-aware representations—either by encoding the schema as part of the input or using schema-specific token prompts—so it can generalize to unseen slot structures at inference time.

In more advanced setups, the model is trained using schema-conditioned generation, where the slot definitions and permissible values are provided dynamically at training time, enabling the model to learn how to produce valid states that conform to varying formats. This schema grounding helps the model avoid hallucinated or invalid slot-value pairs. Additionally, constrained decoding techniques such as integrating finite-state automata may be introduced during training or fine-tuning to reinforce strict structural compliance. Overall, the model learns not only to extract relevant information from natural language but also to format its output to align with dynamically provided dialogue state tracking structures, enabling it to operate effectively across a wide range of domains and session contexts.

The algorithms used to train and operate a system that generates session state tracking statuses based on dynamically determined session state tracking structures typically involve a combination of transformer-based sequence-to-sequence models, schema-guided learning, and constrained decoding techniques. At the core, the model architecture is often a pretrained large language model (LLM) such as T5, BART, or GPT, which is fine-tuned on task-oriented dialogue data using supervised learning. These models leverage attention mechanisms to capture relationships between words in user utterances and map them to structured outputs representing dialogue states.

To incorporate schema-awareness, algorithms often include prompt-based conditioning or schema serialization, where slot names and possible values are embedded into the input sequence, allowing the model to align its output with a specific schema. During inference, constrained decoding algorithms—such as finite-state automaton-guided token masking or prefix-constrained beam search—are employed to ensure that the generated outputs adhere to the predefined grammar and structure of the session state tracking schema. These constraints dynamically restrict the set of permissible tokens at each step, preventing the model from generating syntactically or semantically invalid outputs.

Additionally, some systems may integrate reinforcement learning to optimize dialogue state tracking performance over longer conversations, or use pointer-generator networks to directly copy slot values from user input. The combination of these algorithms enables robust, accurate, and schema-compliant dialogue state tracking that can adapt across various domains with different slot structures.

In some embodiments, a model may be trained to generate database tool requests based on current session states and dynamically determined database tool structures by learning to map structured representations of user intent—typically expressed as slot-value pairs—into executable tool calls that conform to specific APIs or service schemas. Training such a model involves using supervised learning on datasets that contain annotated examples of session dialogue histories, corresponding dialogue states, and ground truth tool calls or API requests. These tool calls are often formatted in JSON or structured function-call templates, showing how various slot values should be mapped to the tool's input parameters. For example, the training data may include a session state like {“type”: “hotel”, “price_range”: “cheap”, “parking”: “yes”} paired with a corresponding tool request such as query_hotels(type=“hotel”, price_range=“cheap”, parking=“yes”).

To enable flexibility across domains and tools, the training data also includes database tool structures or API schemas, often described in OpenAPI or similar formats. These schemas define the expected parameters, their data types, and constraints. The model is trained using schema-conditioned generation algorithms, where the schema itself (e.g., the tool name, argument names, and allowed types) is encoded into the model's input along with the session state. This teaches the model not just to memorize tool call patterns, but to generalize across dynamically changing tool schemas.

The core model is typically a transformer-based sequence-to-sequence architecture (such as T5, BART, or GPT), fine-tuned with teacher forcing to predict well-formed tool requests from structured inputs. To ensure correctness at inference time, constrained decoding algorithms—such as schema-based token filtering, finite-state automata, or structured beam search—may be applied, ensuring only valid function names and arguments are generated. In some settings, the model may also use few-shot learning or prompt engineering to adapt to new APIs with minimal training examples. Altogether, this training process equips the model to accurately translate session states into syntactically valid and semantically meaningful tool calls that interface directly with downstream APIs or database services.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., interpreting a user input, determining a session state tracking structure, determining a network input, determining a database tool structure, etc.).

In some embodiments, the model (e.g., model 302) may automatically perform actions based on outputs 306. In some embodiments, the model (e.g., model 302) may not perform any actions. The output of the model (e.g., model 302) may be used for interpreting a user input, determining a session state tracking structure, determining a network input, determining a database tool structure, etc.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration. For example, the system architecture may use an open API approach to execute calls by leveraging standardized, publicly accessible interfaces that enable dynamic integration with external tools, services, or databases. In this architecture, each callable service—such as a hotel search tool, reservation system, or user profile service—is described using a machine-readable specification, typically in formats like OpenAPI (formerly Swagger). These specifications define the available endpoints, supported methods (e.g., GET, POST), required parameters, expected data types, and response formats. By incorporating these specifications into the system, the architecture can automatically discover, validate, and construct API calls at runtime without requiring hardcoded logic for each tool.

When a user request is processed and transformed into a structured representation (e.g., as a JSON object of slot-value pairs), the system refers to the OpenAPI schema to identify the correct endpoint and structure the request in accordance with the expected API signature. The open API approach also allows the system to dynamically route requests to the appropriate URL, include necessary headers, handle authentication, and process the response in a standardized way. This enables the architecture to support a wide range of services with minimal manual integration, ensuring scalability, modularity, and interoperability across domains. Additionally, the open API model facilitates future expansion of capabilities, as new services can be onboarded simply by supplying a new API specification, which the system can ingest and utilize immediately.

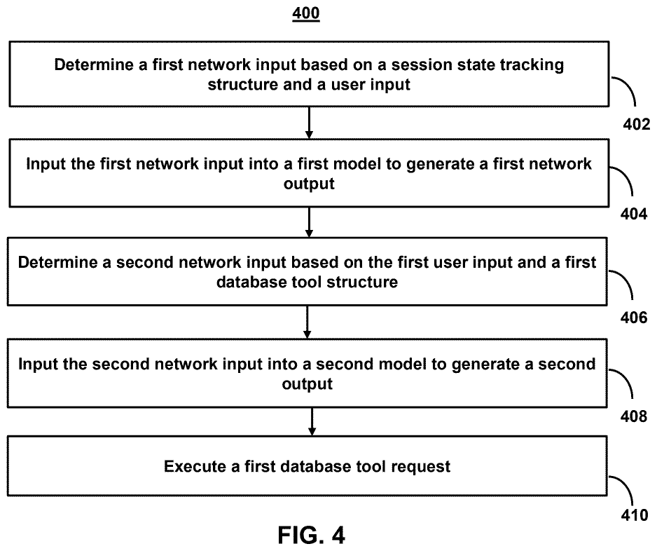

FIG. 4 shows a flowchart of the steps involved in generating outputs using a two-stage architecture, in accordance with one or more embodiments. For example, the system may use process 400 (e.g., as implemented on one or more system components described above) in order to generate secured outputs over computer networks.

In some embodiments, the system may receive a first user input (e.g., an utterance by a user that generates dialogue for an interaction with a user interface) and determine a first session state tracking structure based on the first user input. For example, the system may receive a first user input, such as a spoken or typed utterance—for example, “I'm looking for a cheap hotel with parking”—through a user interface that facilitates interaction between the user and an automated application. Upon receiving this input, the system initiates a session and begins processing the utterance to determine its semantic content. This involves applying natural language understanding (NLU) techniques to extract the user's intent and identify relevant slots, such as price_range and parking. Based on this analysis, the system determines a first session state tracking structure, which is a predefined schema comprising expected slot-value pairs and contextual variables relevant to the dialogue domain (e.g., hotel search). The structure is selected or dynamically instantiated based on the input's domain classification (e.g., travel or accommodation), allowing the system to populate appropriate slots with inferred values. This session state tracking structure then becomes the foundation for maintaining context across the session, ensuring that subsequent user inputs can update or refine the existing state in a coherent and structured manner.

In some embodiments, the system may receive the first user input by receiving a first user utterance and generating a tokenized representation of the first user utterance. For example, the system may receive the first user input by capturing a first user utterance—a spoken or typed sentence submitted through a user interface—and processing it through a series of natural language preprocessing steps. Once the utterance is received, the system transforms the raw text into a tokenized representation, which involves breaking the input down into discrete units such as words, subwords, or symbols (known as tokens). This tokenization process enables the language model or dialogue engine to work with the input in a structured, computationally manageable format. For instance, an utterance like “Find me a cheap hotel with parking” may be tokenized into elements such as [“Find”, “me”, “a”, “cheap”, “hotel”, “with”, “parking”] or further into subword units depending on the tokenizer used. This tokenized representation forms the foundation for downstream tasks such as intent recognition, slot extraction, and session state tracking, as it provides a structured and standardized input format for subsequent processing by neural models or rule-based systems.

In some embodiments, the system may determine the first session state tracking structure based on the first user input by retrieving a plurality of available session state tracking structures and filtering the plurality of available session state tracking structures based on the first user input to select the first session state tracking structure from the plurality of available session state tracking structures. For example, the system may determine the first session state tracking structure based on a first user input by retrieving a plurality of available session state tracking structures, each corresponding to different dialogue domains or task types—such as hotel booking, restaurant reservations, or flight scheduling. These structures are typically predefined and stored in a schema registry or configuration database. Upon receiving and tokenizing the user's input, the system applies intent classification and domain detection techniques to analyze the semantic content of the utterance. For example, if the input is “I need a place to stay that's cheap and has parking,” the system may detect that the user is initiating a hotel-related task. It then filters the available session state tracking structures based on features of the input—such as recognized entities like “stay,” “cheap,” and “parking”—to identify which schema aligns best with the inferred intent and required slots. From this filtered set, the system selects the most appropriate session state tracking structure—such as one that includes price_range, parking, and accommodation_type—and uses it as the basis for populating and tracking the dialogue state throughout the remainder of the session. This selection process ensures that only relevant and contextually accurate structures are applied, enabling robust, domain-aware conversation management.

In some embodiments, the system may determine the first session state tracking structure based on the first user input by determining a subset of predefined slots, determining a range of permissible values for the subset of predefined slots, and interpreting the first user input to populate the subset of predefined slots with respective values within the range. For example, the system may determine the first session state tracking structure based on a first user input by first identifying a subset of predefined slots that are relevant to the user's intent. These slots are part of a broader schema associated with a specific task or domain, such as booking a hotel, and include categories like price_range, location, amenities, or check_in_date. Once the relevant subset of slots is identified—typically through intent classification and semantic analysis of the input—the system proceeds to determine the range of permissible values for each of these slots. These value ranges may be constrained by predefined enumerations (e.g., price_range values like “cheap”, “moderate”, “expensive”), valid formats (e.g., date or time), or domain-specific constraints (e.g., list of supported amenities like “wifi”, “parking”, “pool”). The system then interprets the user's utterance by mapping tokens or phrases to the most appropriate slot-value pairs, ensuring that the extracted values fall within the allowable ranges. For example, given the user input “I need a cheap hotel with parking,” the system may populate the slot price_range with “cheap” and the slot amenities with “parking.” This interpretation process allows the system to construct a valid and structured initial dialogue state, which will be refined and updated as the conversation progresses.

In some embodiments, the system may determine the first session state tracking structure based on the first user input by determining a first encoding, wherein the first encoding comprises slot-value grammar for the first user input and determining a second encoding, wherein the second encoding comprises a rule for a deterministic finite-state automaton for the first encoding. For example, the system may determine the first session state tracking structure based on the first user input by generating two interconnected encodings that together guide the structured interpretation of the input. First, the system creates a first encoding, which represents the user input in terms of a slot-value grammar. This involves parsing the utterance and identifying phrases that correspond to slots (e.g., “cheap”→price_range, “hotel”→accommodation_type, “with parking”→amenities) and organizing them according to a predefined syntactic format, such as slot_name=slot_value;. This encoding acts as a symbolic representation of the user's intent within a constrained grammar that reflects the structure of the domain.

In some embodiments, the system may determine the first session state tracking structure based on the first user input by determining a permissible schema corresponding to the first session state tracking structure and using the permissible schema to determine for the first network input. For example, the system may determine the first session state tracking structure based on the first user input by first identifying a permissible schema that corresponds to the anticipated structure of dialogue state information. This schema serves as a formal definition of the slots and value types relevant to the domain inferred from the user input—for example, hotel booking or restaurant reservations. Upon receiving the user utterance, such as “I'm looking for a cheap hotel with parking,” the system applies domain classification and intent recognition techniques to map the input to a specific dialogue schema that includes slots like price_range, accommodation_type, and amenities.

Once this permissible schema is determined, it becomes the reference framework for constructing the first network input, which is the structured input to a language model or dialogue state tracking module. The system uses the schema to format and constrain the input data by explicitly organizing the recognized slot-value pairs extracted from the user utterance in a way that aligns with the schema's expected structure. For example, it may encode the input as price_range=cheap; accommodation_type=hotel; amenities=parking;, conforming to the grammar specified by the schema. This structured, schema-aligned representation enables the downstream model to generate a well-formed and validated dialogue state, ensuring the session state tracking process begins with a consistent and interpretable foundation.

In some embodiments, the system may determine the first session state tracking structure based on the first user input by determining boundaries for a first session, wherein the first session comprises an interaction between a user and a user interface, determining a first dialogue history corresponding to the first session, and determining, for the first dialogue history, a first dialogue state tracking structure corresponding to the first session state tracking structure. For example, the system may determine the first session state tracking structure based on the first user input by first identifying the boundaries of a first session, which represents a continuous interaction between a user and a user interface. This session is typically initiated when the user sends their initial utterance—such as “I need a cheap hotel with parking”—and continues until the interaction is completed or times out. Upon session initiation, the system begins tracking the session context and creates a corresponding first dialogue history, which records all exchanges between the user and the system. This history includes both user utterances and system responses in chronological order, allowing the system to accumulate conversational context over time.

Using this evolving dialogue history, the system then determines a first dialogue state tracking structure, which corresponds to the session state tracking structure for that particular interaction. This structure captures the user's goals in a structured format, typically as a collection of slot-value pairs derived from the user's utterances. By analyzing the dialogue history, the system can identify relevant slots (e.g., price_range, accommodation_type, amenities) and populate them with values extracted from user inputs. As the conversation progresses, this structure is continually updated to reflect changes, clarifications, or additions to the user's intent. This approach allows the system to maintain a coherent and dynamic representation of the user's needs throughout the session, supporting accurate task fulfillment and personalized responses.

At step 402, process 400 (e.g., using one or more components described above) determine a first network input based on a session state tracking structure and a user input. For example, the system may determine a first network input based on a first session state tracking structure and a first user input. For example, system may determine a first network input based on a first session state tracking structure and a first user input by integrating both structured and unstructured information into a unified representation suitable for processing by a language model or dialogue engine. After receiving the first user input—such as “I'm looking for a cheap hotel with parking”—the system processes it to identify relevant slot-value pairs and populate the session state tracking structure accordingly (e.g., price_range=cheap, amenities=parking). To generate the first network input, the system combines this partially filled session state structure with the original user utterance, typically by encoding them together in a prompt or input sequence formatted according to the model's requirements. For example, the system might create an input like: “User: I'm looking for a cheap hotel with parking. Current state: price_range=cheap; amenities=parking;”—This combined representation preserves the raw linguistic context of the user's utterance while anchoring it with a structured summary of the recognized intent, enabling the model to reason over both elements in tandem. This approach improves the model's ability to generate accurate and schema-conforming outputs—such as completing the dialogue state or preparing parameters for a subsequent tool call—by grounding free-form user input in a deterministic, domain-specific structure.

In some embodiments, the system may determine the first network input based on the first session state tracking structure and the first user input by retrieving a plurality of approved arguments for first session state tracking structure and formatting the first user input based on the plurality of approved arguments to determine the first network input. For example, the system may determine the first network input based on the first session state tracking structure and the first user input by retrieving a plurality of approved arguments associated with the session state tracking structure and using them to guide the formatting of the input. These approved arguments correspond to predefined slot names or input parameters that the system recognizes and supports within the context of the target domain—such as price_range, location, accommodation_type, and amenities in a hotel booking schema. Once the user provides an input—for example, “I need a cheap hotel with parking”—the system identifies candidate values from the utterance that align with these approved arguments. The system then formats the user input by mapping the extracted values to the appropriate argument labels, resulting in a structured representation that conforms to the session schema. For instance, it may produce a formatted string such as price_range=cheap; accommodation_type=hotel; amenities=parking;. This formatted representation becomes the first network input, which is fed into a language model or dialogue state module for further processing. By using the approved arguments as constraints, the system ensures that the network input is syntactically valid and semantically aligned with the task-specific schema, thus enabling consistent and reliable dialogue state tracking across different user sessions.

In some embodiments, the system may determine the first network input based on the first session state tracking structure and the first user input by retrieving a plurality of approved arguments for first session state tracking structure and formatting the first user input based on the plurality of approved arguments to determine the first network input. For example, the system may determine the first network input based on the first session state tracking structure and the first user input by first retrieving a plurality of approved arguments associated with the session state tracking structure. These approved arguments represent the valid and predefined slot names that define what the system is capable of tracking for a specific task or domain—for example, slots like price_range, area, amenities, and accommodation_type in a hotel booking context. Once these arguments are retrieved, the system processes the user input—such as “I need a cheap hotel with parking”—to identify and extract content that corresponds to those arguments. Next, the system formats the user input by aligning recognized entities with the approved slot names. For instance, it maps “cheap” to price_range, “hotel” to accommodation_type, and “parking” to amenities, thereby generating a structured intermediate representation. This representation may be formatted as a semicolon-separated string or a JSON-like object, such as price_range=cheap; accommodation_type=hotel; amenities=parking;. This structured output becomes the first network input, which is passed into a language model or a downstream dialogue processing module. By leveraging the list of approved arguments as a filter and guide, the system ensures that only relevant and schema-compliant elements are included in the network input, promoting accurate dialogue state tracking and facilitating reliable task execution in subsequent stages.

In some embodiments, the system may determine the first network input based on the first session state tracking structure and the first user input by retrieving a plurality of classes for the first session state tracking structure and processing the first user input based on the plurality of classes to determine the first network input. For example, the system may determine the first network input based on the first session state tracking structure and the first user input by retrieving a plurality of classes associated with the session state tracking structure. These classes define the data model for the domain-specific schema and encapsulate slots as class attributes—each with associated data types, value constraints, or validation logic. For example, in a hotel booking context, the system might retrieve classes such as HotelBooking and Hotel, where each class contains structured fields like price_range, area, stars, and amenities. These classes act as blueprints that describe the allowable structure of dialogue state information and dictate how input should be interpreted and organized. Once these classes are retrieved, the system processes the first user input—such as “I need a cheap hotel with parking”—by parsing it and mapping phrases or tokens to specific attributes within the class definitions. Using natural language understanding techniques, the system identifies that “cheap” aligns with the price_range field, “hotel” maps to accommodation_type, and “parking” corresponds to an amenities flag or list. These values are then structured according to the schema defined by the retrieved classes, often in a format such as key-value pairs or a JSON object, e.g., {“price_range”: “cheap”, “accommodation_type”: “hotel”, “amenities”: [“parking”]}. This structured data, derived from class-based validation and alignment, forms the first network input, which is passed into a language model or downstream module for further dialogue processing. By anchoring user input to predefined class structures, the system ensures that the network input is both syntactically valid and semantically aligned with the target domain schema.

At step 404, process 400 (e.g., using one or more components described above) input the first network input into a first model to generate a first network output. For example, the system may input the first network input into a first model to generate a first network output, wherein the first model is trained to generate session state tracking statuses based on dynamically determined session state tracking structures. The system may input the first network input into a first model to generate a first network output by feeding the structured representation—derived from the combination of the first user input and the session state tracking structure—into a language model or dialogue processing model specifically trained for dialogue state tracking. This first model is trained to interpret natural language inputs in the context of dynamically determined session schemas, which means it can flexibly adapt to different domains or task-specific slot configurations. The model uses the input, which may include both the original user utterance and a partially filled structure of slot-value pairs, to reason about which slots are active, what values are being specified, and how the current state should be updated. During this process, the model leverages its training on diverse conversational patterns and slot-filling scenarios to infer or confirm values for each slot defined in the schema. For example, given a network input like “User: I need a cheap hotel with parking. Current state: {}”, the model may output a structured update such as {“price_range”: “cheap”, “accommodation_type”: “hotel”, “amenities”: [“parking”]}. This first network output represents the updated dialogue state and conforms to the dynamically determined session structure. The system ensures that the model's generation process is constrained—often via schema enforcement mechanisms like finite-state automata—so that the output is not only semantically meaningful but also structurally valid, enabling consistent tracking of the user's goals throughout the session.

At step 406, process 400 (e.g., using one or more components described above) determine a second network input based on the first user input and a first database tool structure. For example, the system may determine a second network input based on the first user input and a first database tool structure. The system may determine a second network input based on the first user input and a first database tool structure by aligning the content of the user's request with the expected input format required by the tool or API that will be used to fulfill the task. The first database tool structure defines the schema for interacting with an external data source or service, specifying permissible parameters (e.g., name, type, area, stars, internet, parking) along with their data types and constraints. Once the system has parsed the user input—for example, “I need a cheap hotel with parking”—it maps relevant components of the utterance to corresponding fields defined in the tool structure. Using this mapping, the system constructs the second network input by formatting the extracted values into a representation that complies with the tool's invocation requirements. For instance, it may generate a structured object such as {“type”: “hotel”, “price_range”: “cheap”, “parking”: “yes”}, which reflects the parameters expected by the database query method (e.g., query_hotels). This second network input encapsulates both the user's intent and the technical constraints of the database tool, enabling the system to accurately translate natural language into a machine-interpretable form. By grounding the input in the tool's schema, the system ensures that the resulting query or action is valid and executable, thereby facilitating seamless integration between conversational understanding and backend functionality.

In some embodiments, the system may generate the second network input based on the first user input and the first database tool structure by determining a first heuristic based on the first user input and the first database tool structure, comparing the first heuristic to a threshold heuristic, and determining to generate the second network input based on comparing the first heuristic to the threshold heuristic. For example, the system may generate the second network input based on the first user input and the first database tool structure by applying a heuristic-driven decision process that evaluates whether sufficient and valid information is available to formulate a meaningful tool call. First, the system determines a first heuristic, which quantifies the alignment between the extracted content of the user's utterance and the required or optional parameters defined in the database tool structure. This heuristic may measure factors such as the number of matched parameters, the completeness of slot-value extraction, or the confidence scores of entity recognition—for example, identifying that the user mentioned price_range=“cheap” and parking=“yes” in a request for a hotel. Next, the system compares the computed heuristic to a threshold heuristic, which represents a predefined minimum level of information or confidence required to reliably generate a database query or API call. If the first heuristic meets or exceeds the threshold, the system proceeds to generate the second network input by formatting the matched values into a structured tool-specific format, such as a JSON object or function call with the appropriate parameters. However, if the heuristic falls below the threshold—indicating that key information is missing or ambiguous—the system may instead choose to ask a follow-up question to the user for clarification before proceeding. This comparison ensures that tool calls are only generated when the input is sufficiently complete and aligned with the database tool structure, thereby improving reliability and preventing malformed or ineffective queries.

In some embodiments, the system may generate the second network input based on the first user input and the first database tool structure by determining a plurality of arguments based on the first user input and the first database tool structure, comparing the plurality of arguments to a required argument, and determining to generate the second network input based on determining that the required argument is not part of the plurality of arguments. For example, the system may generate the second network input based on the first user input and the first database tool structure by first identifying a plurality of arguments—that is, slot-value pairs or query parameters—that can be extracted from the user's input and mapped to the fields defined in the tool's schema. These arguments are derived through natural language understanding techniques that align user-provided phrases with structured fields, such as “cheap” mapping to price_range or “hotel” to type. Simultaneously, the system references the first database tool structure, which specifies a set of required and optional arguments needed to successfully execute a tool call or database query. After forming the plurality of candidate arguments from the user input, the system performs a comparison against the required argument(s) defined in the tool structure. This comparison checks whether all mandatory fields necessary for a valid tool call—such as type or area—are present in the extracted argument set. If the system determines that a required argument is missing from the plurality of arguments, it may decide not to generate the second network input yet, recognizing that the query would be incomplete or invalid. Instead, the system may prompt the user for the missing information to complete the input. This decision-making step ensures that the second network input is only generated when the user's input satisfies the minimum structural requirements defined by the database tool schema, thus preserving the validity and effectiveness of downstream tool calls.

In some embodiments, the system may generate the second network input based on the first user input and the first database tool structure by determining a first confidence in a context determined based on the first user input and the first database tool structure, comparing the first confidence to a threshold confidence, and determining to generate the second network input based on comparing the first confidence to the threshold confidence. For example, the system may generate the second network input based on the first user input and the first database tool structure by employing a confidence-based evaluation mechanism that assesses the quality and certainty of the interpreted input. First, the system analyzes the user's utterance—such as “I'm looking for a cheap hotel with parking”—and maps extracted elements like “cheap” and “parking” to arguments defined in the database tool structure (e.g., price_range, amenities). As part of this process, the system determines a first confidence score, which reflects how reliably the system has interpreted the user input in the context of the database tool schema. This score may be based on factors such as the clarity of the user's language, the certainty of slot-value mapping, or alignment with known schema types and acceptable value ranges. Once the first confidence is calculated, the system compares it to a threshold confidence, which represents the minimum confidence level required to proceed with generating a tool request. If the first confidence exceeds or meets this threshold, the system determines that it has sufficient certainty to generate the second network input—a structured tool invocation formatted with the recognized arguments, such as {“type”: “hotel”, “price_range”: “cheap”, “parking”: “yes”}. However, if the confidence falls below the threshold, the system may instead choose to delay tool invocation and prompt the user for clarification or additional information. This confidence-based gating mechanism ensures that tool requests are only issued when the system is reasonably certain of the user's intent, thereby reducing errors and improving the reliability of the task execution process.

In some embodiments, the system may generate the second network input based on the first user input and the first database tool structure by determining an acceptance state is met and generating a JSON-formatted dialogue state in response to the acceptance state being met. For example, the system may generate the second network input based on the first user input and the first database tool structure by monitoring the structured decoding process to determine when an acceptance state is met—typically through the use of a deterministic finite-state automaton (FSA). As the system processes the user input, it incrementally constructs a sequence of tokens that represent slot-value pairs, guided by a predefined grammar that enforces the valid structure of a dialogue state. This grammar may follow rules such as slot_name→“=”→slot_value→“;”, ensuring that each part of the input conforms to the format required by the tool schema.

The FSA tracks the progression of this decoding process in real time and transitions between internal states as valid tokens are emitted. When the system reaches an acceptance state—a condition that signifies a complete and syntactically valid representation of all required fields—the automaton signals that the decoding is complete and the generated structure is valid. In response to this, the system generates a JSON-formatted dialogue state, such as: “{“type”: “hotel”, “price_range”: “cheap”, “amenities”: [“parking”]}”. This structured output serves as the second network input, which can be used directly for invoking a database query or external API defined by the database tool structure. By tying the generation of the network input to a verified acceptance state, the system ensures that only fully-formed, schema-compliant outputs are used in downstream operations, improving both reliability and task execution accuracy.

At step 408, process 400 (e.g., using one or more components described above) input the second network input into a second model to generate a second output. For example, the system may input the second network input into a second model to generate a second output, wherein the second model is trained to generate database tool requests based on current session states and dynamically determined database tool structures.

For example, A system may input the second network input into a second model to generate a second output by passing a structured representation—typically a JSON object or equivalent formatted input—into a model that has been trained to map current session context to precise tool invocation commands. This second network input combines information from the current session state, such as extracted slot-value pairs (e.g., price_range=“cheap”, type=“hotel”, parking =“yes”), with the constraints and structure defined by the dynamically determined database tool structure, such as expected argument names, data types, and required fields.

The second model—which may be a fine-tuned large language model or a specialized encoder-decoder system—is trained to interpret such inputs and generate well-formed database tool requests. These outputs are formatted in a way that conforms to API or database query requirements, ensuring that all required fields are present and all values fall within accepted ranges. For example, given a session where the user seeks a hotel with specific features, the second model might output a query like: {“query_hotels”: {“type”: “hotel”, “price_range”: “cheap”, “parking”: “yes”}}. This second output is then ready to be executed by a database layer or service interface. The model's training enables it to generalize across different schemas and tool structures, adapting dynamically to various domains or task templates while maintaining strict adherence to tool invocation formats. This process ensures seamless integration between conversational understanding and task execution.

At step 410, process 400 (e.g., using one or more components described above) executes a first database tool request. For example, the system may execute a first database tool request based on the second output. The system may execute a first database tool request based on the second output by interpreting the structured command or query generated by the second model and routing it to the appropriate backend service or database. The second output, typically formatted in JSON or another machine-readable schema, contains all necessary parameters and values required to perform the task—for example, querying a hotel database with fields like type: “hotel”, price_range: “cheap”, and parking: “yes”. Upon receiving this output, the system validates the request to ensure that it aligns with the schema defined in the database tool structure, checking for completeness, correct types, and acceptable values. Once validated, the system passes the request to the corresponding tool interface or API endpoint, such as a RESTful service, GraphQL endpoint, or SQL-based backend. The tool or service then executes the query using the provided parameters to retrieve relevant data or perform the requested action (e.g., fetching hotel listings that match the criteria). The response from the tool is typically returned to the system in a structured format, such as a list of hotel entries or a confirmation of an action performed. This result can then be incorporated into a natural language response and presented to the user via the dialogue interface. By converting the model-generated output into a real-world tool invocation, the system completes the task-oriented dialogue cycle and fulfills the user's intent.

In some embodiments, the system may execute the first database tool request based on the second output by determining a first application programming interface for executing the first database tool request and determining a first location for directing the first database tool request. For example, A system may execute the first database tool request based on the second output by first identifying the appropriate application programming interface (API) responsible for handling the request. This involves analyzing the structure and semantics of the second output—which typically contains a function-like command (e.g., query_hotels) and associated parameters—to determine which backend service or API method is required to fulfill the task. The system uses metadata defined in the database tool structure, such as tool annotations or operation mappings, to match the output to a specific API function that is capable of processing the request.

Once the relevant API is identified, the system then determines the first location or endpoint URL where the request should be directed. This location could correspond to a RESTful service, internal microservice, or external database interface that handles task-specific queries. For instance, the system may resolve the request to an endpoint like https://api.example.com/hotels/search. With both the API function and target location resolved, the system packages the request—often in JSON format—into an HTTP POST or GET call, including any required headers or authentication credentials. The request is then sent to the designated location, where the API processes it and returns a response. This two-step process of selecting the correct API and endpoint ensures that the system reliably converts abstract, model-generated outputs into executable service calls that fulfill the user's intent within a live, real-world environment.

In some embodiments, the system may execute the first database tool request based on the second output by determining a first tool name for the first database tool request and generating a function based on the first tool name. For example, the system may execute the first database tool request based on the second output by first identifying a first tool name embedded in or inferred from the output, which specifies the operation to be performed. This tool name corresponds to a specific function or service defined within the system's tool-calling framework—such as “query_hotels” or “book_flight”—and serves as a semantic key for selecting the appropriate backend capability. Once the tool name is determined, the system generates a function call or structured invocation corresponding to that tool. This involves assembling the parameters provided in the second output—such as “price_range”: “cheap” and “parking”: “yes”—into the input signature expected by the designated function.

For example, if the tool name is “query_hotels”, the system may construct a function call like query_hotels(price_range=“cheap”, parking=“yes”) or its equivalent JSON format, depending on the execution environment. This function may be dynamically invoked in languages that support runtime function resolution, or mapped to a static API interface in systems with pre-defined tool schemas. The function encapsulates all necessary logic for querying a backend database, filtering results, and returning relevant matches. By using the tool name as a directive and constructing the function call accordingly, the system ensures that the database tool request is executed accurately, with parameters correctly aligned to the tool's operational definition. This process enables seamless translation from language model output to live system action, fulfilling the user's request in a structured and automated way.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for generating secured outputs over computer networks using a two-stage architecture.

2. The method of any one of the preceding embodiments, further comprising: receiving a first user input; determining a first session state tracking structure based on the first user input; determining a first network input based on the first session state tracking structure and the first user input; inputting the first network input into a first model to generate a first network output, wherein the first model is trained to generate session state tracking statuses based on dynamically determined session state tracking structures; determining a first database tool structure; generating a second network input based on the first user input and the first database tool structure; inputting the second network input into a second model to generate a second output, wherein the second model is trained to generate database tool requests based on current session states and dynamically determined database tool structures; and executing a first database tool request based on the second output.

3. The method of any one of the preceding embodiments, wherein receiving the first user input further comprises: receiving a first user utterance; and generating a tokenized representation of the first user utterance.

4. The method of any one of the preceding embodiments, wherein determining the first network input based on the first session state tracking structure and the first user input further comprises: retrieving a plurality of approved arguments for first session state tracking structure; and formatting the first user input based on the plurality of approved arguments to determine the first network input.

5. The method of any one of the preceding embodiments, wherein determining the first network input based on the first session state tracking structure and the first user input further comprises: retrieving a plurality of approved arguments for first session state tracking structure; and formatting the first user input based on the plurality of approved arguments to determine the first network input.

6. The method of any one of the preceding embodiments, wherein determining the first network input based on the first session state tracking structure and the first user input further comprises: retrieving a plurality of classes for the first session state tracking structure; and processing the first user input based on the plurality of classes to determine the first network input.

7. The method of any one of the preceding embodiments, wherein determining the first session state tracking structure based on the first user input further comprises: retrieving a plurality of available session state tracking structures; and filtering the plurality of available session state tracking structures based on the first user input to select the first session state tracking structure from the plurality of available session state tracking structures.

8. The method of any one of the preceding embodiments, wherein determining the first session state tracking structure based on the first user input further comprises: determining a subset of predefined slots; determining a range of permissible values for the subset of predefined slots; and interpreting the first user input to populate the subset of predefined slots with respective values within the range.

9. The method of any one of the preceding embodiments, wherein determining the first session state tracking structure based on the first user input further comprises: determining a first encoding, wherein the first encoding comprises slot-value grammar for the first user input; determining a second encoding, wherein the second encoding comprises a rule for a deterministic finite-state automaton for the first.

10. The method of any one of the preceding embodiments, wherein determining the first network input based on the first session state tracking structure and the first user input further comprises: determining a permissible schema corresponding to the first session state tracking structure; and using the permissible schema to determine for the first network input.

11. The method of any one of the preceding embodiments, wherein determining the first session state tracking structure based on the first user input further comprises: determining boundaries for a first session, wherein the first session comprises an interaction between a user and a user interface; determining a first dialogue history corresponding to the first session; and determining, for the first dialogue history, a first dialogue state tracking structure corresponding to the first session state tracking structure.

12. The method of any one of the preceding embodiments, wherein generating the second network input based on the first user input and the first database tool structure further comprises: determining a first heuristic based on the first user input and the first database tool structure; comparing the first heuristic to a threshold heuristic; and determining to generate the second network input based on comparing the first heuristic to the threshold heuristic.

13. The method of any one of the preceding embodiments, wherein generating the second network input based on the first user input and the first database tool structure further comprises: determining a plurality of arguments based on the first user input and the first database tool structure; comparing the plurality of arguments to a required argument; and determining to generate the second network input based on determining that the required argument is not part of the plurality of arguments.

14. The method of any one of the preceding embodiments, wherein generating the second network input based on the first user input and the first database tool structure further comprises: determining a first confidence in a context determined based on the first user input and the first database tool structure; comparing the first confidence to a threshold confidence; and determining to generate the second network input based on comparing the first confidence to the threshold confidence.

15. The method of any one of the preceding embodiments, wherein generating the second network input based on the first user input and the first database tool structure further comprises: determining an acceptance state is met; and generating a JSON-formatted dialogue state in response to the acceptance state being met.

16. The method of any one of the preceding embodiments, wherein executing the first database tool request based on the second output comprises: determining a first application programming interface for executing the first database tool request; and determining a first location for directing the first database tool request.

17. The method of any one of the preceding embodiments, wherein executing the first database tool request based on the second output comprises: determining a first tool name for the first database tool request; and generating a function based on the first tool name.

18. One or more non-transitory, computer-readable mediums storing instructions that, when executed by a data processing apparatus, cause the data processing apparatus to perform operations comprising those of any of embodiments 1-17.

19. A system comprising one or more processors; and memory storing instructions that, when executed by the processors, cause the processors to effectuate operations comprising those of any of embodiments 1-17.

20. A system comprising means for performing any of embodiments 1-17.

What is claimed is:

1. A system for generating secured outputs over computer networks using a two-stage architecture, the system comprising:
one or more processors; and
one or more non-transitory, computer-readable media having instructions recorded thereon that when executed by the one or more processors cause operations comprising:
initiating over a first computer network a secured user session;
receiving a first secured user input during the secured user session;
determining a first session state tracking structure based on the first secured user input;
determining a first network input based on the first session state tracking structure and the first secured user input;
inputting the first network input into a first model to generate a first network output, wherein the first model is trained to generate session state tracking statuses based on dynamically determined session state tracking structures;
determining a first database tool structure;
determining a second network input based on the first secured user input and the first database tool structure;
inputting the second network input into a second model to generate a second output, wherein the second model is trained to generate database tool requests based on current session states and dynamically determined database tool structures; and
executing a first database tool request based on the second output.

2. A method for generating outputs over computer networks using a two-stage architecture, the method comprising:
receiving a first user input;
determining a first session state tracking structure based on the first user input;
determining a first network input based on the first session state tracking structure and the first user input;
inputting the first network input into a first model to generate a first network output, wherein the first model is trained to generate session state tracking statuses based on dynamically determined session state tracking structures;
determining a first database tool structure;
determining a second network input based on the first user input and the first database tool structure;
inputting the second network input into a second model to generate a second output, wherein the second model is trained to generate database tool requests based on current session states and dynamically determined database tool structures; and
executing a first database tool request based on the second output.

3. The method of claim 2, wherein receiving the first user input further comprises:
receiving a first user utterance; and
generating a tokenized representation of the first user utterance.

4. The method of claim 2, wherein determining the first network input based on the first session state tracking structure and the first user input further comprises:
retrieving a plurality of approved arguments for first session state tracking structure; and
formatting the first user input based on the plurality of approved arguments to determine the first network input.

5. The method of claim 2, wherein determining the first network input based on the first session state tracking structure and the first user input further comprises:
retrieving a plurality of approved arguments for first session state tracking structure; and
formatting the first user input based on the plurality of approved arguments to determine the first network input.

6. The method of claim 2, wherein determining the first network input based on the first session state tracking structure and the first user input further comprises:
retrieving a plurality of classes for the first session state tracking structure; and
processing the first user input based on the plurality of classes to determine the first network input.

7. The method of claim 2, wherein determining the first session state tracking structure based on the first user input further comprises:
retrieving a plurality of available session state tracking structures; and
filtering the plurality of available session state tracking structures based on the first user input to select the first session state tracking structure from the plurality of available session state tracking structures.

8. The method of claim 2, wherein determining the first session state tracking structure based on the first user input further comprises:
determining a subset of predefined slots;
determining a range of permissible values for the subset of predefined slots; and
interpreting the first user input to populate the subset of predefined slots with respective values within the range.

9. The method of claim 2, wherein determining the first session state tracking structure based on the first user input further comprises:
determining a first encoding, wherein the first encoding comprises slot-value grammar for the first user input; and
determining a second encoding, wherein the second encoding comprises a rule for a deterministic finite-state automaton for the first encoding.

10. The method of claim 2, wherein determining the first network input based on the first session state tracking structure and the first user input;
further comprises:
determining a permissible schema corresponding to the first session state tracking structure; and
using the permissible schema to determine for the first network input.

11. The method of claim 2, wherein determining the first session state tracking structure based on the first user input further comprises:
determining boundaries for a first session, wherein the first session comprises an interaction between a user and a user interface;
determining a first dialogue history corresponding to the first session; and
determining, for the first dialogue history, a first dialogue state tracking structure corresponding to the first session state tracking structure.

12. The method of claim 2, wherein generating the second network input based on the first user input and the first database tool structure further comprises:
determining a first heuristic based on the first user input and the first database tool structure;
comparing the first heuristic to a threshold heuristic; and
determining to generate the second network input based on comparing the first heuristic to the threshold heuristic.

13. The method of claim 2, wherein generating the second network input based on the first user input and the first database tool structure further comprises:
determining a plurality of arguments based on the first user input and the first database tool structure;
comparing the plurality of arguments to a required argument; and
determining to generate the second network input based on determining that the required argument is not part of the plurality of arguments.

14. The method of claim 2, wherein generating the second network input based on the first user input and the first database tool structure further comprises:
determining a first confidence in a context determined based on the first user input and the first database tool structure;
comparing the first confidence to a threshold confidence; and
determining to generate the second network input based on comparing the first confidence to the threshold confidence.

15. The method of claim 2, wherein generating the second network input based on the first user input and the first database tool structure further comprises:
determining an acceptance state is met; and
generating a JSON-formatted dialogue state in response to the acceptance state being met.

16. The method of claim 2, wherein executing the first database tool request based on the second output comprises:
determining a first application programming interface for executing the first database tool request; and
determining a first location for directing the first database tool request.

17. The method of claim 2, wherein executing the first database tool request based on the second output comprises:
determining a first tool name for the first database tool request; and
generating a function based on the first tool name.

18. One or more non-transitory, computer-readable media, comprising instructions that, when executed by one or more processors, cause operations comprising:
determining a first network input based on a first session state tracking structure and a first user input;
inputting the first network input into a first model to generate a first network output, wherein the first model is trained to generate session state tracking statuses based on dynamically determined session state tracking structures;
determining a second network input based on the first user input and a first database tool structure;
inputting the second network input into a second model to generate a second output, wherein the second model is trained to generate database tool requests based on current session states and dynamically determined database tool structures; and
executing a first database tool request based on the second output.

19. The one or more non-transitory, computer-readable media of claim 18, wherein receiving the first user input further comprises:
receiving a first user utterance: and
generating a tokenized representation of the first user utterance.

20. The one or more non-transitory, computer-readable media of claim 18, wherein determining the first network input based on the first session state tracking structure and the first user input further comprises:
retrieving a plurality of approved arguments for first session state tracking structure; and
formatting the first user input based on the plurality of approved arguments to determine the first network input.
